(19) United States
(12) Patent Application Publication
(10) Pub. No.: US 2017/0105329 A1
(43) Pub. Date: Apr. 20, 2017

(54) Crabgrass & Weed EXtractor Drill Bit

(71) Applicant: Carl Edwin Smith, JR., Harlan, KY (US)

(72) Inventor: Carl Edwin Smith, JR., Harlan, KY (US)

(21) Appl. No.: 15/296,035

(22) Filed: Oct. 18, 2016

Related U.S. Application Data
(60) Provisional application No. 62/242,977, filed on Oct. 16, 2015.

(51) Int. Cl. A01B 1/18

(52) U.S. Cl. CPC A01B 1/18

(57) ABSTRACT

The disclosed invention describes a device and means for removing weeds and the like from the ground. The device is a simply attachment for a drill. The device comprises a body with a shaft protruding from the center and at least two prongs protruding from the opposite side of the body at distances equidistant from the center. The free end of the shaft is placed into a drill and the prongs are forced into the ground so that they are placed around a weed. The user operates the drill, spinning the prongs around the weed. The prongs entangle the weeds roots and bore a small hole in the ground, allowing the user to easily remove the weed. The prongs are then placed into the ground close to the hole and the drill is slowly operated, thus refilling the hole.

### CROSS REFERENCE TO RELATED APPLICATIONS

This Nonprovisional Utility patent application claims the benefit of Provision Patent Application No. 62/242,977, filed on Oct. 16, 2015, on behalf of the same inventor of this current Nonprovisional patent application, Carl Edwin Smith, Jr.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The inventor's local golf course's greens had an unusually high amount of crab grass during the summer and fall of 2015 growing in all ten greens (nine-hole course and one practice putting green). He and his colleagues were preparing the course to host a “Ryder Cup” event with a friendly rival community in his region. His country club has been on shaky grounds financially and able to employ only one full-time grounds crewman/greens superintendent. The club was financially unable to buy pre-emergent crab grass killer and the greens superintendent didn't have time to try to pull the crab grass. When the inventor would be playing or practicing, he would try to use a divot fixer tool, twisting it then pulling upwards and grasping the central area of the crab grass with the other thumb and index finger. After doing this twenty or thirty times (especially if extracting some from the “fringe”, an area of grass around the green that is allowed to grow somewhat higher therefore the roots grow somewhat deeper—crab grass located on the fringe on top of the ground is bigger, thicker, wider and grows deeper into the ground), it was not unusual for a couple of tendons in each of his wrists to be sore for several days. September of 2015 was a particularly ideal time for crab grass to proliferate on the golf course's putting greens. The inventor suddenly thought of the idea of a crab grass removal drill bit. He placed a standard 4 cm long drill bit proximally in the same axis as the prong/tines on a typical golf divot fixing tool, gluing them together with J-B Weld® Original Cold Weld Formula Steel Reinforced Epoxy. He would use this two-pronged instrument to puncture either side of an individual crab grass root. He saw the potential for this as there are thousands of golf courses across the world, and his wife has a flowerbed full of flowers and unwanted grasses/weeds/vines. He and his 3 children have a “Victory Garden” full of produce and crab grass and weeds. The yard adjacent to his swimming pool became all crab grass in the summer of 2015, due to the winter pool cover being laid on it to dry. Three weeks later all the normal grass was dead, and crab grass is typically the first invader of a barren area.

Once crab grass is established, chemicals are of no use. In the fall, the crab grass will die and will become an ugly brown dead piece of grass that, by March and April, leaves a barren area which is fertile ground for crab grass seed. It is reported that one crab grass plant can produce up to 150,000 seed per year. Crab grass does not grow back each year from the roots, but rather from their tiny seeds, which find their way down into the soil. Chemicals are expensive. The human body 2 is prone to “overuse syndromes” such as “Carpal Tunnel Syndrome,” when performing a particular movement on a repetitive basis (example a baseball pitcher's rotator cuff and elbow).

The inventor searched local stores, Google, as well as eBay and Amazon.com, finding nothing on the market like his invention. He searched the U.S. Patent office database and was pleased to find this was uncharted territory. He spoke with golf course superintendents and experienced players and found that there was nothing that they suggested other than pre-emergent chemicals and extracting the crab grass, if so desired, with the stab of a knife or by the use of a golf ball divot fixing tool that is used to repair ball marks made when a ball lands on a golf putting green. Having played golf for 54 years, the inventor was well aware there was not anything on the market like the weed removal drill bit that he has invented.

Chemical weed killers may kill more than the intended target. In particular the grass on golf putting greens is cut at about 3/16 inch or less. The longer the grass grows, the deeper and longer its roots become. Conversely, when grass is cut very short, such as on a golf putting green, the grass root structure is very short. This makes the grass on golf course putting greens very delicate, thus easily injured by chemicals, adverse weather conditions, and heavy foot traffic.

Using weed killers in a vegetable garden can be potentially dangerous. The use of chemicals in flower gardens is also filled with potential disasters.

Mechanical weed removal can be manually painful on several parts of the body 2 (fingers, wrists, hands, back, and knees) and mentally frustrating. It is labor-intensive and, therefore, can be costly.

Utilizing his tool, the inventor has been able to extract 101 pieces of crab grass on a putting green in 5 minutes (20.2 crab grass per minute) on one trial and 88 in another 5-minute trial (17.6 crab grass per minute). It only takes him about 2 minutes to repair 101 holes created by a 5-minute extraction.

The amount of force/pull needed to extract larger growths of crab grass from the fringe of the golf putting green (the collar of grass that encircles the green, typically being 2-10 feet in width; the grass here is slightly longer than what is on the golf green putting surface, usually cut to the same length as the “teeing ground” of the golf course, but very short compared to the “fairway” and especially the “rough” which is typically allowed to grow 2 inches to 6 inches in length) is significant. Removing crab grass from the “fairway” is arduous, even for an athletic adult male. Removing Dallisgrass, crab grass, and goosegrass can be tough work and tough on the body 2. Goosegrass in 2015 has become one of the top problem weeds for golf course superintendents. It is resistant to multiple chemicals, and, therefore, physical extraction is the method of by which it can be controlled.

The use of existing hand weeding tools does not offer the advantages delineated above of the invention. The inventor has had overwhelmingly positive feedback, seeing smiles of amazement from golfers, golf pros, and golf course superintendents.

A search of the USPTO patent database reveals several patents that tackle the problem of weeding in similar ways, but none of these patents describe a device that is as simple and easy to manufacture and this invention, while also utilizing a motorized means of operation. In addition, this invention can be used to repair the hole that is left after a weed or other plant is removed from the ground.

### BRIEF SUMMARY OF THE INVENTION

The present invention is a sturdy weeding tool device, in a variety of sizes, designed to remove various weeds and grasses when used as an attachment to a drill. The device is especially good for removing weeds that have a “tap root,” without causing significant disturbance to immediately adjacent grass turf and sub-soil. It can remove weeds with lengthy tap-roots, average-depth bushy-hair roots, and near-surface vine-type roots, as well as surface growth of weeds, grasses, and vines. The device comprises a shaft 1, a body 2, and at least two prongs 3. The shaft 1 is connected to one side of the body 2, and the prongs 3 are connected to the opposite side of the body 2 and point in the opposite direction than the shaft 1. The shaft 1 is connected to the center of the side of the body 2 to which it is attached. The prongs 3 are connected to the opposite side of the body 2 in such a way that the prongs 3 are not at the center of the body 2, but each prong is equidistant from the center of the body 2 (i.e., every prong is at an equal distance from the center of said body 2 as every other prong). The shaft 1 is shaped in such a way that it will fit into the chuck of a drill (the drill bit receptacle) like a standard drill bit—substantially circular, hexagonal, or other equilateral shape, in cross-section—so that it can easily fit into a standard household battery-powered drill, electric drill, or a manually powered drill of like size. When the shaft 1 is inserted into a drill, it extends from the drill to the body 2 of the device, and two or more prongs 3 extend from the side of the body 2 of the device opposite the shaft 1. The prongs 3 are straight and elongated, substantially like nails, and may be circular, square, rectangular, hexagonal or otherwise geometrically shaped in cross-section with the proximal and distal ends being of the same size or with the distal end being smaller in cross-section than the proximal end. The surface of the prongs 3 can be smooth or can have ridges like the threads of a screw, or can be otherwise fluted or textured. When the shaft 1 of the device is inserted into the chuck (drill bit receptacle) of a drill, the prongs 3 will point away from the drill. Because the shaft 1 is connected to the center of the body 2 of the device, and the prongs 3 are not connected to the center of the device, but are each equidistant from the center, when the drill is operated, the shaft 1 rotates like any drill bit would rotate, and the prongs 3 travel around the line of rotation in a circular motion. In order to use the device to remove weeds or the like, one must simply insert the shaft 1 into a common drill, push the tips of the prongs 3 into the ground around the weed to be removed, and slowly operate the drill. The prongs 3 will bore a cylindrical hole around the weed, capturing the weed's root structure and freeing the weed from the surrounding earth. When the drill is pulled away from the ground with the device, the weed will come out of the ground, leaving a small, easily reparable hole in its place. The hole in the ground can be easily repaired with the invention. Simply push the prongs 3 into the ground substantially ½ of an inch from the hole and operate the drill so that it slowly turns substantially 15 degrees. Once this is done substantially two or three times from different locations that are substantially ½ of an inch away from the hole, the hole will be filled with earth, and the ground surface will have suffered minimal damage.

The shaft 1 can be of varying lengths, but it is perhaps most useful when it long enough so that the user can pierce the ground with the prongs 3 from a substantially upright, standing position. The user can push the prongs 3 into the ground by stepping on the body 2 of the device, then he or she can operate the drill to remove the weed.

In an alternate process of using the device, the prongs 3 are placed into above-ground weeds, grasses, or vines without penetrating the ground. When the drill is operated, the prongs 3 grab and entangle said weeds, grasses, or vines and rip them out of the ground.

### BRIEF DESCRIPTION OF THE DRAWING

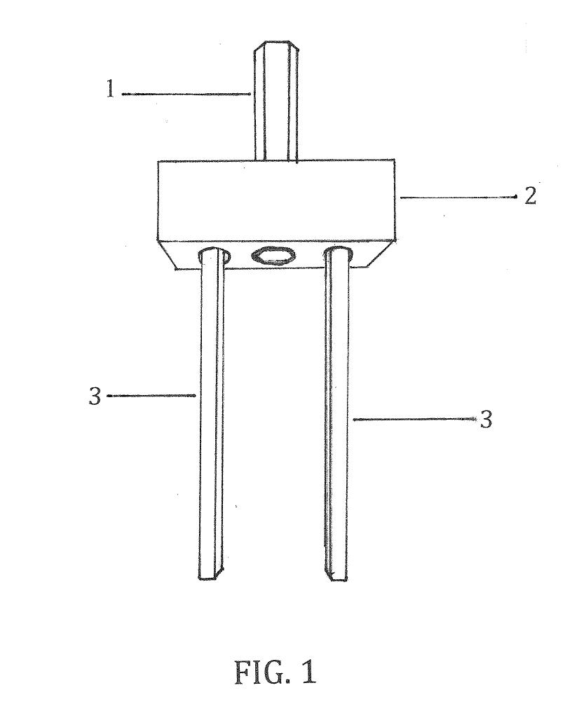

The drawing in FIG. 1 shows the invention from an angle that reveals all of the functional parts. This particular drawing is of the invention as it is currently being produced, as described below. The shaft 1 protrudes from the top of the body 2. The top of the shaft 1 (from the perspective of this drawing) fits into the chuck (drill bit receptacle) of an electric drill (not illustrated). The two prongs 3 protrude from the bottom of the body 2. Though this diagram shows a short shaft 1, the preferred embodiment is one in which the shaft 1 is long enough to allow the user to utilize the invention from a standing, substantially upright position. Thus the shaft 1 should be long enough to extend from a drill in a standing, substantially upright person's hand to the ground.

### DETAILED DESCRIPTION OF THE INVENTION

The device is a weeding tool devise comprising a shaft 1, a body 2, and at least two prongs 3. The shaft 1 is connected to one side of the body 2, and the prongs 3 are connected to the opposite side of the body 2 and point in the opposite direction than the shaft 1. The shaft 1 is connected to the center of one side of the body 2. The prongs 3 are connected to the opposite side of the body 2 in such a way that the prongs are not at the center of the body 2, but each prong is equidistant from the center of the body 2 (i.e., every prong is at an equal distance from the center of said body 2 as every other prong). The shaft 1 is shaped in such a way that it will fit into the chuck of a drill (the drill bit receptacle) like a standard drill bit—substantially circular, hexagonal, or other equilateral shape, in cross-section—so that it can easily fit into a standard household battery-powered drill, electric drill, or a manually powered drill of like size. When the shaft 1 is inserted into a drill, it extends from the drill to the body 2 of the device, and two or more prongs 3 extend from the side of the body 2 of the device opposite the shaft 1. The prongs 3 are straight and elongated, substantially like nails, and may be circular, square, rectangular, hexagonal or otherwise geometrically shaped in cross-section with the proximal and distal ends being of the same size or with the distal end being smaller in cross-section than the proximal end. The surface of the prongs 3 can be smooth or can have ridges like the threads of a screw, or can be otherwise fluted or textured. The prongs 3 can have other similar shapes while remaining consistent with the teachings of the present invention. When the shaft 1 of the device is inserted into the chuck (drill bit receptacle) of a drill, the prongs 3 will point away from the drill. Because the shaft 1 is connected to the center of the body 2 of the device, and the prongs 3 are not connected to the center of the device, but are each equidistant from the center, when the drill is operated, the shaft 1 rotates like any drill bit would rotate, and the prongs 3 travel around the line of rotation in a circular motion. In order to use the device to remove weeds or the like, one must simply insert the shaft 1 into a common drill, push the tips of the prongs 3 into the ground around the weed to be removed, and slowly operate the drill. The prongs 3 will bore a cylindrical hole around the weed, capturing the weed's root structure and freeing the weed from the surrounding earth. When the drill is pulled away from the ground with the device, the weed will come out of the ground, leaving a small, easily reparable hole in its place. The hole in the ground can be easily repaired with the invention. Simply push the prongs 3 into the ground substantially ½ of an inch from the hole and operate the drill so that it turns substantially 15 degrees. Once this is done substantially two or three times from different locations that are substantially ½ of an inch away from the hole, the hole will be filled with earth, and the ground surface will have suffered minimal damage.

In an alternate process of using the device, the prongs 3 are placed into above-ground weeds, grasses, or vines without penetrating the ground. When the drill is operated, the prongs 3 grab and entangle said weeds, grasses, or vines and rip them out of the ground.

The device can be made of any hard, sturdy material, including, but not limited to, medium grade strength steel. If the device is used only on golf putting greens the material need not be as sturdy. The device can be manufactured utilizing a simple mold, by pouring molten metal into a mold (casting). Alternatively, the device can be manufactured from two pieces spot-welded together: the shaft 1 from a bar of hexagonal steel and the body 2 and prongs 3 from a mold. Also, the device can be manufacturing using any other method that is known in the art, including, but not limited to, machining the shaft 1 and prongs 3 from existing steel stock and welding them to a body 2 made by casting, machining all of the parts from existing steel stock and welding them together, or any combination of casting and machining parts and welding them together. Separate parts can also be attached using other forms of adhesion, other than welding, that are known in the art.

In practice, the inventor has produced the invention as follows: the body 2 is made by cutting a substantially 1 and ½ inch long section of ½-inch wide by ½-inch deep stock steel bar. Two substantially 2/16-inch holes are drilled through the body 2 such that each hole is the same distance from the center of the length of the body 2. The edges of such holes that are proximal to the center of the length of the body 2 are substantially 9/16 inch apart, and the edges of such holes that are distal to the center of the length of the body 2 are substantially 13/16 inch apart. A third hole that is substantially 2/16-inch wide is drilled through the center of the length of said body 2. Each hole is centered along the ½-inch width of said body 2. A 1 and ¼ inch section of a ¼-inch wide piece of a stock hexagonal steel rod is hammered into the center hole, so that the proximal end of said rod is flush with the surface of the body 2. A tapered, substantially rectangular-in-cross-section masonry/concrete nail (2 and ½ inches long and 6/32 inches wide at the wider end and 4/32 inches wide at the narrower end) is hammered into each of the non-centered holes, being hammered through the holes (with the narrower ends going into the holes first) from the side of the body 2 where the shaft 1 is protruding and being hammered until the wider end of the masonry nails are flush with the surface of the body 2 from which the shaft 1 protrudes. If a longer shaft 1 is used (perhaps a 22-inch to 26-inch shaft 1), so that the device can be operated from a substantially upright, standing position, the body 2 is longer (substantially 1 and ¾ inches long), and the edges of the outer holes that are proximal to the center of the length of the body 2 are substantially 14/16 inch apart, and the edges of such holes that are distal to the center of the length of the body 2 are substantially 18/16 inch apart. The longer body 2 makes it easier to step on the body 2 to force the prongs 3 into the earth. It may be preferable to have a body 2 that is 2 inches long when making the device with the longer shaft 1. Note that these specific dimensions are illustrative, rather than limiting.

The number of prongs 3 can vary. The 2-prong version will be the most commonly utilized design, but 3 and 4 prong versions in certain circumstances will have more functionality when dealing with a larger, more-stout weeds. However, any number of prongs 3 can be used on a device like the present invention while remaining consistent with the teachings of the present invention.

Looking up the axis of the shaft 1, toward the chuck of the drill to which it is attached (similar to looking from the open end of a rifle barrel (where the bullet exits the barrel) down the barrel of a rifle), the prongs 3 of the 2-prong version would ideally be located at the 3:00 and 9:00 positions which makes them 180° apart going around the clock (see the diagram of a clock face in the drawings) numbered from 1 through 12 with the 12 o'clock position being at the top, the 3 o'clock position being rotated 90° to the right (from the standpoint of a viewer looking at the face of the clock is located on the right side), the 6 o'clock position being an additional 90° thereby being located at the bottom of the clock, and the 9 o'clock position being located on the left side of the clock an additional 90° around (the entire circle being 360°). The 3-prong version would ideally have its prongs 3 located at the 12:00, 4:00 and 8:00 positions (120° between each prong going around the clock). The 4-prong version would ideally have its prongs 3 located at the 12:00, 3:00, 6:00, and 9:00 positions (90° between each prong going around the clock). However, any number of prongs 3 can be placed in a variety of positions while remaining consistent with the teachings of the present invention.

Though the device as described can be used with a hand-held drill, a significantly larger version of the device could be used with a larger drill, or other rotating machine, while remaining consistent with the teachings of the present invention. Such a larger device could be used to remove bushes or even trees, while retaining a significant portion of their root structure.

The beauty of this design lies in its ability to rapidly extract the weed in question without disturbing the surrounding area, leaving a small cylindrical hole that is easily repaired utilizing the same tool to repair the hole by punching it into the area surrounding the hole in two or more locations (for instance at the 12:00 and 6:00 o'clock position around the hole) and gently, briefly squeezing the trigger on a variable speed drill in order for it to turn substantially 15 degrees. In the golf green application a 3.6-volt or 4-volt battery-powered drill supplies the ideal amount of energy; the 3.6 and 4-volt sizes are light-weight (in particular, drills with a lithium battery rather a nickel cadmium battery), easy to use, and very portable. It can be used in damp or wet conditions. This is of extreme importance in removing weeds from putting greens used in the sport of golf (as said putting greens are located in outdoor potentially damp or rainy environments on a golf course), a practice facility, or at a single home dwelling practice putting green.

When using the larger sized (or large-gap) versions of the device, it is better to use a 12, 18 or 20-volt lithium battery drill.

A version of the device with prongs 3 that are longer and further apart would be well suited to clear an area grown up with grasses/weeds/vines. The prongs 3 of the device should be placed in the midst of the grass/weeds/vines (not into the ground) in order to wind the grass/weeds/vines like cotton candy is wound around a stick. Utilizing this larger version of the device enables you to pull a lot of weeds and long grass out without having to do so completely manually. It is likely that the operator will still need to manually pull some on the drill itself in order to free the mass of grasses/weeds/vines wound around the large weeding drill bit from its attachment to the ground. The advantage of using this is that the grasses/weeds/vines do not have to be gathered from the ground by hand one at the time, but rather can be removed in bunches.

Versions of the device that have their prongs 3 designed like a “screw thread” (with spiraled elevated ridges running down each prong) or like a drill bit (with spiraled flutes running down each prong) enable the device to have a better grasp of the weed or grass structures or vines. The screw thread version is not necessary for use on golf putting greens. A screw thread is an elevation or “ridge” wrapped diagonally around and down (helical) the cylindrical or conical prongs 3, with the former being called a “straight thread” and the latter called a “tapered thread.” Prongs 3 designed like a standard drill bit have recessed grooves called “flutes” (instead of elevations) helically spiraled down the axis of each prong.

What is claimed is:

1. A weed removing device comprising:
a body; and
a shaft that is centrally attached to said body; and
two or more prongs that are peripherally attached to the opposite side of said body and are parallel to each other and to the vector of the shaft

2. A means of using the device described in claim 1 wherein:
the end of the shaft which is distal to the body is inserted into a drill; and
the prongs are inserted into the soil around a weed; and
the drill is operated so to twist the prongs around the weed
